(19) United States
(12) Patent Application Publication
(10) Pub. No.: US 2009/0114501 A1
(43) Pub. Date: May 7, 2009

(54) Frictional engagement device

(75) Inventors: Shintaro Goto, Nissin-shi (JP); Terasu Harashima, Toyota-shi (JP); Naoki Kato, Togo-cho (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/289,143

(22) Filed: Oct. 21, 2008

(30) Foreign Application Priority Data
Nov. 7, 2007 (JP) 2007-289776

(51) Int. Cl. F16D 13/56

(52) U.S. Cl. 192/89.22

(57) ABSTRACT

A wave washer is interposed on an inner peripheral groove via a snap ring. The wave washer urges a radiation direction outer end of a bottom plate member against a wall surface side of the inner peripheral groove in a direction of an axis.

### INCORPORATION BY REFERENCE

The disclosure of Japanese Patent Application No. 2007-289776 filed on Nov. 7, 2007 including the specification, drawings and abstract is incorporated herein by reference in its entirety.

### BACKGROUND OF THE INVENTION

1. Field of the Invention

The invention relates to a frictional engagement device. More particularly, the invention relates to a frictional engagement device that is provided in an automatic transmission or the like and has an engaging/releasing part for establishing and releasing engagement among a plurality of friction plates.

2. Description of the Related Art

A general automatic transmission that is mounted in an automobile or other vehicle has a frictional engagement device for changing a power transmission passage of the automatic transmission. Such a frictional engagement device establishes and releases engagement between a clutch and brake by establishing and releasing engagement among a plurality of friction plates by means of a clutch drum by, for example, controlling the drive of a piston on the basis of hydraulic pressure supplied from a hydraulic controller.

The one shown in FIG. 7 is known as this type of conventional frictional engagement device (see, for example, Japanese Patent Application Publication No. 2007-16860 (JP-A-2007-16860)). In FIG. 7, an automatic transmission 1 is configured by a plurality of multiplate clutches, a multiplate brake, and a combination of a plurality of planetary gears including a sun gear, pinion gear and ring gear.

The multiplate clutches 2 that function as frictional engagement devices configuring the automatic transmission 1 intermittently transmit the power of the engine from an input shaft to the planetary gears. The multiplate clutches 2 are configured by a plurality of outer clutch plates 4, which are friction plates extending in a direction of an axis of an axis member 3, an inner clutch plate 5, which is a friction plate disposed between adjacent outer clutch plates 4 and meshing with the outer clutch plates 4, and a clutch drum 6 that holds the outer clutch plates 4.

The clutch drum 6 is connected to a piston 8 via a snap ring 7, the piston 8 being capable of moving in the direction of the axis of the axis member 3. The piston 8 is urged against one end of the direction of the axis of the axis member 3 by a spring 9.

Furthermore, in this automatic transmission 1, there are formed a hydraulic pressure chamber 10 that is provided adjacent to a piston 8 and opposite to a spring 9, and an oil passage 11 communicated with the hydraulic pressure chamber 10. Moreover, a pressing ring 12 with an L-shaped cross section is attached to the other end of the clutch drum 6 in the direction of the axis via a snap ring 13. This snap ring 13 is fitted into an inner peripheral groove formed on the other end of the clutch drum 6 in the direction of the axis.

In addition, a disc spring-like cushion plate 15 is provided on the abovementioned other end of the clutch drum 6 in the direction of the axis via a snap ring 14. This cushion plate 15 is brought into sliding contact with an outer clutch plate 4 provided on the right-hand side in FIG. 7.

In the automatic transmission 1 configured as described above, in a state in which operating oil is not supplied to the hydraulic pressure chamber 10, the clutch drum 6 is urged rightward in FIG. 7 through the piston 8 so that the pressing ring 12 is released from the outer clutch plate 4 by an urging force of the spring 9. At this moment, a tiny gap is formed between the outer clutch plate 4 and an inner clutch plate 5, and the transmission of the power from the input shaft to the planetary gears is blocked.

Next, when the operating oil is supplied to the hydraulic pressure chamber 10 through the oil passage 11, the piston 8 moves in the direction of the axis of the axis member 3 against the urging force of the spring 9, and consequently the clutch drum 6 moves in the direction of the axis member 3 along with the piston 8 and then the pressing ring 12 presses the outer clutch plate 4. As a result, the outer clutch plate 4 and inner clutch plate 5 are pressure-bonded to each other and the power of the engine is transmitted from the input shaft to the planetary gears.

In the automatic transmission 1 configured as described above, the pressing ring 12 that is provided on the other end of the clutch drum 6 in the direction of the axis presses the outer clutch plate 4 from one side of the direction of the axis toward the other side of the same. Therefore, the outer clutch plate 4 and inner clutch plate 5 are assembled inside the clutch drum 6 and thereafter the pressing ring 12 is attached to the clutch drum 6, in order to improve assemblability of the outer clutch plate 4 and inner clutch plate 5 assembled inside the clutch drum 6. As a result, the outer clutch plate 4 and inner clutch plate 5 can be assembled into the clutch drum 6 without the distraction of the pressing ring 12.

Incidentally, in the automatic transmission 1 configured as described above, because the pressing ring 12 that is a separate component from the clutch drum 6 is assembled into the clutch drum 6, the cushion plate 15 is interposed between the clutch drum 6 and the pressing ring 12 to prevent looseness caused in the direction of the axis between the clutch drum 6 and the pressing ring 12.

Specifically, in the frictional engagement devices such as the multiplate clutches 2, it is essential to properly manage the space between the pressing ring 12 and the outer clutch plate 4 in order to reduce engagement shock.

If the space between the pressing ring 12 and the outer clutch plate 4 is large, at least a required amount of operating oil needs to be supplied to the hydraulic pressure chamber 10, which brings the pressing ring 12 into contact with the outer clutch plate 4 by a great force. Consequently, the engagement force for bringing the outer clutch plate 4 into engagement with the inner clutch plate 5 increases, resulting in increase of so-called “transmission shock (engagement shock)”.

Therefore, when looseness occurs in the direction of the axis between the clutch drum 6 and the pressing ring 12, management of the space between the pressing ring 12 and the outer clutch plate 4 becomes extremely complicated.

In the conventional automatic transmission 1, therefore, the cushion plate 15 is interposed between the pressing ring 12 and the outer clutch plate 4. The cushion plate 15 is bent when bringing the pressing ring 12 into engagement with the outer clutch plate 4 via the cushion plate 15, and then the engagement force for bringing the outer clutch plate 4 into engagement with the inner clutch plate 5 is reduced so that the transmission shock is reduced.

However, according to such a conventional frictional engagement device, due to the looseness that occurs in the direction of the axis between the clutch drum 6 and the pressing ring 12, the pressing ring 12 is drastically moved by the loosened amount when abutting the pressing ring 12 against the outer clutch plate 4 during speed change, causing a drastic change in pressure of the operating oil.

Furthermore, the necessity of disposing the cushion plate 15 between the clutch drum 6 and the pressing ring 12 increases not only the production cost of the frictional engagement device but also the length (entire length) of the axial direction of the frictional engagement device and thus enlarges the frictional device.

### SUMMARY OF THE INVENTION

The invention provides a small frictional engagement device that is capable of reducing the production cost thereof while making the hydraulic characteristic smooth and reducing the engagement shock by preventing the occurrence of looseness between a bottom plate member and a piston member.

A frictional engagement device according to an aspect of the invention includes: a first cylindrical member; a plurality of first friction plates that are fitted into an inner peripheral surface of the first cylindrical member and arranged in a direction of an axis of the first cylindrical member; a second cylindrical member provided in an inner peripheral part of the first cylindrical member; a plurality of second friction plates that are provided on an outer peripheral surface of the second cylindrical member and arranged in a direction of an axis of the second cylindrical member so as to be interposed alternately with the first friction plates; and an engaging/releasing part that is provided in an outer peripheral part of the first cylindrical member to establish and release engagement between each first friction plate and each second friction plate, and includes a tubular piston member that has an abutting part, one end of which in the direction of the axis can be abutted against either the first friction plate or the second friction plate, a bottom plate member, a radiation direction outer end of which is fitted into an inner peripheral groove formed on the other end of the piston member in the direction of the axis and which defines a hydraulic pressure chamber between the first cylindrical member and the bottom plate member, and an urging member that is interposed on the inner peripheral groove of the piston member and urges the radiation direction outer end of the bottom plate member against a wall surface of the inner peripheral groove in the direction of the axis.

According to this configuration, the urging member is interposed on the inner peripheral groove of the piston member to urge the outer end of the bottom plate member in the radiation direction against the wall surface of the inner peripheral groove in the direction of the axis. Therefore, looseness can be prevented from occurring between the bottom plate member and the piston member.

As a result, the space between the abutting part of the piston member and the first friction plate can be managed easily, and the first friction plate and the second friction plate can be brought into engagement with each other via the bottom plate member and the piston member by supplying a required amount of operating oil to the hydraulic pressure chamber, whereby engagement shock can be prevented from increasing.

Moreover, because looseness is prevented from occurring between the bottom plate member and the piston member, the bottom plate member and the piston member can be prevented from moving relatively to each other when bringing the first friction plate and the second friction plate into engagement with each other. Accordingly, not only is it possible to prevent the pressure of the operating oil from changing drastically, but also it is possible to make the hydraulic characteristic smooth.

As a result, not only is it possible to eliminate the conventional cushion plate and reduce the entire length of the frictional engagement device, but also it is possible to reduce the number of parts and the production cost of the frictional engagement device.

When the cushion plate exists, a time lag, which is a time period during which the cushion plate is bent when bringing the first friction plate and the second friction plate into engagement with each other, extends a time period during which the first friction plate and the second friction plate are brought into engagement with each other. In the invention, however, since the cushion plate can be eliminated, the piston member may be moved by the distance between the abutting part of the piston member and the first friction plate, and therefore the time period during which the first friction plate and the second friction plate are brought into engagement with each other can be reduced.

According to the above aspect, the urging member may be configured by a wave washer that is formed into a wave along a peripheral direction.

According to this configuration, use of this simply configured, inexpensive wave washer can prevent looseness from occurring between the bottom plate member and the piston member. As a result, not only is it possible to assemble the frictional engagement device without any difficulty but also it is possible to prevent an increase of the production cost of the frictional engagement device.

The aspect of the invention provides the small frictional engagement device that is capable of reducing the production cost thereof while making the hydraulic characteristic smooth and reducing the engagement shock by preventing the occurrence of looseness between the bottom plate member and the piston member.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a cross-sectional diagram of an embodiment of a frictional engagement device according to the invention where substantial parts of a drive unit for a vehicle having the frictional engagement device are shown;

FIG. 2 is a diagram of the embodiment of the frictional engagement device according to the invention for explaining how a clutch and a brake are engaged with each other in order to establish each gear stage of an automatic transmission;

FIG. 3 is a cross-sectional diagram of the embodiment of the frictional engagement device according to the invention where substantial parts of the automatic transmission having the frictional engagement device are shown;

FIG. 4 is a cross-sectional diagram of the embodiment of the frictional engagement device according to the invention where substantial parts of a piston member are shown;

FIG. 5A is a front view of a wave washer according to the embodiment of the frictional engagement device of the invention;

FIG. 5B is a side view of the wave washer according to the embodiment of the frictional engagement device of the invention;

FIG. 6A is a front view of a wave washer of a different shape according to the embodiment of the frictional engagement device of the invention;

FIG. 6B is a side view of this wave washer according to the embodiment of the frictional engagement device of the invention; and

FIG. 7 is a cross-sectional diagram showing substantial parts of an automatic transmission having a conventional frictional engagement device.

### DETAILED DESCRIPTION OF EMBODIMENTS

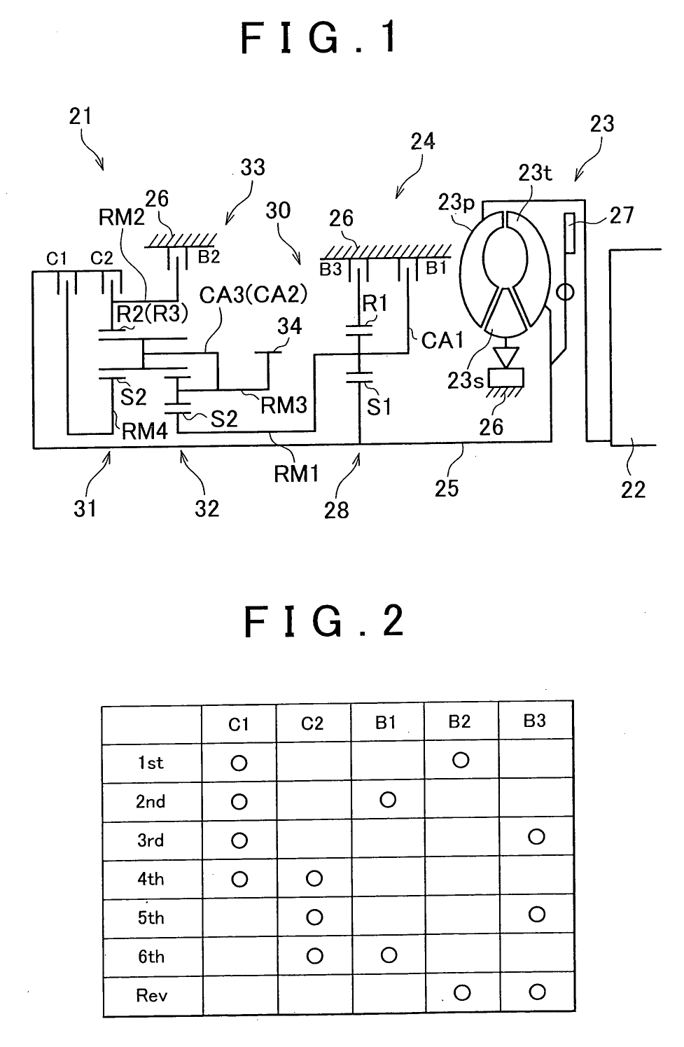

Hereinafter, an embodiment of the frictional engagement device according to the invention is described with reference to the drawings. FIGS. 1 to 6 are diagrams each showing the embodiment of the frictional engagement device according to the invention, and this embodiment shows an example in which the frictional engagement device is applied to an automatic transmission.

In FIG. 1, a drive unit 21 for a vehicle, adopted in a front-engine front-drive (FF) vehicle, has an engine 22 as a drive source for travel. An output of the engine 22 configuring an internal combustion engine is transmitted to right and left drive wheels via a torque converter 23 that functions as a fluid type transmission device, an automatic transmission 24, a differential gear unit which is not shown, and a pair of axles.

The torque converter 23 has a pump impeller 23p coupled to a crankshaft of the engine 22, a turbine impeller 23t coupled to an input shaft 25 of the automatic transmission 24, and a stator impeller 23s coupled to a housing case 26 via a one-way clutch, and transmits power via fluid.

A lockup clutch 27 is provided between the pump impeller 23p and the turbine impeller 23t. When the lockup clutch 27 is engaged the pump impeller 23p and the turbine impeller 23t are rotated integrally.

The automatic transmission 24 has, on a coaxial line, a first speed change part 30 configuring a single pinion type first planetary gear unit 28 as a main body, and a second speed change part 33 configuring a single pinion type second planetary gear unit 31 and double pinion type third planetary gear unit 32 as main bodies, wherein the speed of the rotation of the input shaft 25 is changed and output from an output gear 34.

The input shaft 25 is a turbine shaft that rotates integrally with the turbine impeller 23t of the torque converter 23. The output gear 34 is meshed with the differential gear unit directly or via a counter shaft to drive to rotate the right and left drive wheels. Note that the automatic transmission 24 and the torque converter 23 are substantially symmetrical with respect to a centerline, and the illustration of the bottom half of the centerline is omitted in FIG. 1.

The first planetary gear unit 28 configuring the first speed change part 30 has three rotational elements, a sun gear S1, carrier CA1 and ring gear R1. The sun gear S1 is coupled to the input shaft 25 and driven to rotate, and the ring gear R1 is selectively coupled to the housing case 26, a non-rotating member, via a third brake B3 so that the carrier CA1 is rotated at reduced speed in relation to the input shaft 25 and the rotation is output.

The second planetary gear unit 31 and third planetary gear unit 32 configuring the second speed change part 33 are partially coupled to each other to configure four rotational elements, RM1, RM2, RM3 and RM4.

Specifically, the first rotational element RM1 is configured by a sun gear S3 of the third planetary gear unit 32. A ring gear R2 of the second planetary gear unit 31 and a ring gear R3 of the third planetary gear unit 32 are coupled to each other to configure the second rotational element RM2, and a carrier CA2 of the second planetary gear unit 31 and a carrier CA3 of the third planetary gear unit 32 are coupled to each other to configure the third rotational element RM3. In addition, the fourth rotational element RM4 is configured by a sun gear S2 of the second planetary gear unit 31.

In the second planetary gear unit 31 and the third planetary gear unit 32, the carrier CA2 and carrier CA3 are configured by the same member and the ring gear R2 and ring gear R3 are also configured by the same member. Moreover, the second planetary gear unit 31 and the third planetary gear unit 32 have a Ravigneaux type planetary gear train in which a pinion gear P of the second planetary gear unit 31 also functions as a pinion gear of the third planetary gear unit 32.

The first rotational element RM1 (sun gear S3) is selectively coupled to the housing case 26 by a brake B1 and thereby stops rotating. The second rotational element RM2 (ring gears R2, R3) is selectively coupled to the housing case 26 by a second brake B2 and thereby stops rotating.

The fourth rotational element RM4 (sun gear S2) is selectively coupled to the input shaft 25 via a first clutch C1, and the second rotational element RM2 (ring gears R2, R3) is selectively coupled to the input shaft 25 via a second clutch C2.

Moreover, the first rotational element RM1 (sun gear S3) is coupled to the carrier CA1 of the first planetary gear unit 28, and the third rotational element RM3 (carriers CA2, CA3) is integrally coupled to the output gear 34 to output its rotation.

The first brake B1, second brake B2, third brake B3, first clutch C1 and second clutch C2 are multiplate frictional engagement devices that are frictionally engaged by hydraulic cylinders. The engagement/release conditions of the first brake B1, second brake B2, third brake B3, first clutch C1 and second clutch C2 are switched so that six forward gear stages and one reverse gear stage are established.

An operation table of FIG. 2 shows the relationship of the operational states of the clutches and brakes to each gear stage, wherein “O” indicates engagement. In the automatic transmission 24 of this embodiment, the multi-stage transmission, i.e., the six forward gear stages, can be achieved by bringing the two clutches C1, C2 and any two of the three brakes B1, B2, B3 into engagement.

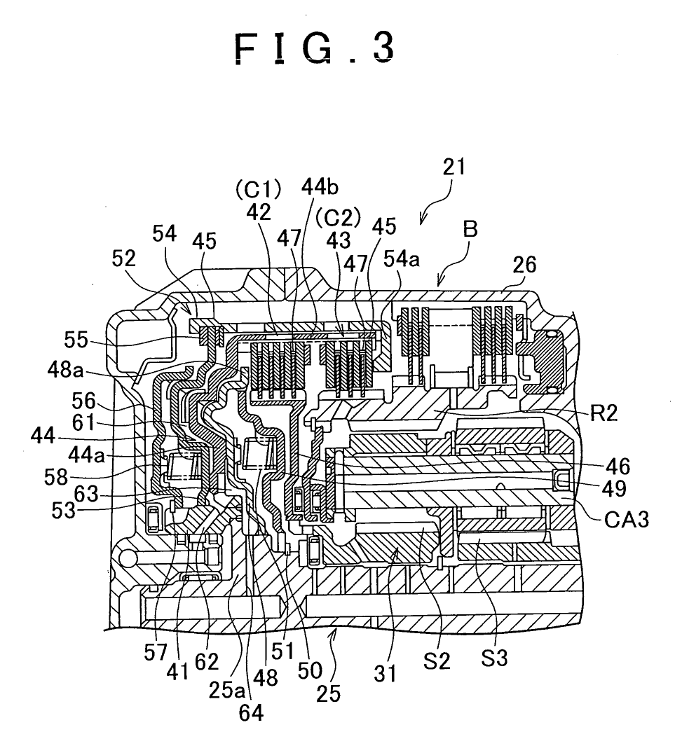

FIG. 3 illustrates the second speed change part 33 of the automatic transmission 24. The input shaft 25 is supported in the housing case 26 via a bearing so as to be relatively rotatable and is provided with a collar part 25a extending vertically with respect to an axis of the input shaft 25. An outer rim of the collar part 25a of the input shaft 25 is provided with an annular base member 41 that is integrally welded to the outer rim and supported so as to be relatively rotatable with respect to the housing case 26.

A clutch drum 44 for supporting a first frictional engagement element 42 configuring the first clutch C1 and a second frictional engagement element 43 configuring the second clutch C2 is integrally welded to an outer peripheral surface of the base member 41, which approaches the second planetary gear unit 31. The clutch drum 44 rotates integrally with the input shaft 25.

The clutch drum 44 serving as the first cylindrical member is a bottomed cylindrical member with an opening in the direction of the axis, and is configured by a substantially disc-like bottom plate part 44a, an inner peripheral surface of which is welded to the outer peripheral surface of the base member 41, and a cylindrical tubular part 44b that is coupled to the outer peripheral surface of the bottom plate part 44a and extends parallel to the axis of the input shaft 25 in a direction of the second planetary gear unit 31.

An inner peripheral surface of the tubular part 44b of the clutch drum 44 is provided with a spline tooth extending longitudinally, and outer rims of a plurality of separate plates 45 serving as the first friction plates of the first frictional engagement element 42 configuring the first clutch C1 are spline-fitted on the bottom plate part 44a side of the tubular part 44b.

The outer rims of the plurality of separate plates 45 of the second frictional engagement elements 43 configuring the second clutch C2 are further spline-fitted opened side of the tubular part 44b. Specifically, an inner peripheral surface of the clutch drum 44 is provided with the plurality of separate plates 45.

The first frictional engagement element 42 is configured by the plurality of separate plates 45 that are spline-fitted into the tubular part 44b, and plurality of friction plates (second friction plates) 47 that are interposed between the separate plates 45 and spline-fitted into an outer peripheral surface of a clutch hub 46 that is coupled to the sun gear S2 of the second planetary gear unit 31 to transmit the rotation.

The second frictional engagement device 43, on the other hand, is configured by the plurality of separate plates 45, the outer rims of which are spline-fitted into the inner peripheral surface of the tubular part 44b, and the plurality of friction plates 47 that are interposed between the separate plates 45 and spline-fitted into an outer peripheral surface of the ring gear R2 that is shared by the second planetary gear unit 31 and the third planetary gear unit 32.

Specifically, the second cylindrical member is configured by the sun gear S2, the clutch hub 46 connected to the sun gear S2, and the ring gear R2, and these sun gear S2, clutch hub 46 and ring gear R2 are provided on the inner peripheral part of the clutch drum 44.

The friction plates 47 are arranged in the direction of the axis of the sun gear S2 and ring gear R2 so as to be interposed alternately with the separate plates 45.

Moreover, a first piston 48 and spring bearing plate 49 for pressing the first frictional engagement element 42 from the clutch drum 44 side are disposed between the clutch drum 44 and the clutch hub 46.

The first piston 48 is attached to the input shaft 25 via a sealant so that an inner peripheral surface is slidable in the direction of the axis, and an outer rim of the first piston 48 extends toward the first fictional engagement element 42 and is provided with an abutting part 48a that can be abutted against the leftmost friction plate 47. Note that the abutting part 48a may be abutted not only against the friction plate 47 but also against the separate plate 45 by positioning the rightmost separate plate 45 to the right-hand side of the rightmost friction plate 47.

The spring bearing plate 49 is brought into abutment against a snap ring 50 fitted into the input shaft 25 so that the spring bearing plate 49 is inhibited from moving to one side of the direction of the axis. Furthermore, the spring bearing plate 49 is inhibited from moving to the other side of the direction of the axis by a return spring 51 that is interposed between the first piston 48 and the spring bearing plate 49 and urges the first piston 48 to abut it against the bottom plate part 44a of the clutch drum 44.

A hydraulic pressure chamber 63 is defined between the first piston 48 and the bottom plate part 44a, and the operating oil is supplied to this hydraulic pressure chamber 63 via an oil passage 64. Once the operating oil is supplied to this hydraulic pressure chamber 63, the first piston 48 moves to the right in FIG. 3 against the urging force of the return spring 51, and accordingly the abutting part 48a of the first piston 48 abuts against the leftmost friction plate 47 and presses this friction plate 47. As a result, the friction plates 47 and the separate plates 45 are brought into engagement and thereby the gear stage of the automatic transmission 24 is changed.

A second piston 52 serving as engaging/releasing part is disposed in an outer peripheral of the clutch drum 44 to cover the clutch drum 44.

The second piston 52, a bottomed tubular member with an opening in the direction of the axis, is fitted into the outer peripheral surface of the base member 41 via a sealant so as to be slidable, and configured by a substantially disc-like bottom plate member 53 extending substantially vertically with respect to the axis of the input shaft 25, a tubular piston member 54 that extends from a radiation direction outer end of the bottom plate member 53 toward the second frictional engagement element 43 parallel to the direction of the axis of the input shaft 25 and has an abutting part 54a that can be abutted against the rightmost friction plate 47 located at one end in the extending direction, and a snap ring 55 that fixes the bottom plate member 53 to an inner peripheral surface of the piston member 54 on one side of the direction of the axis.

The inner peripheral surface of the piston member 54 has a plurality of longitudinal protrusions arranged at equal angular intervals. These protrusions are fitted into concave grooves provided on an outer peripheral surface of the tubular part 44b of the clutch drum 44 so as to be slidable in the direction of the axis. Therefore, the second piston 52 and the clutch drum 44 can rotate integrally.

On the back of the bottom plate member 53 of the second piston 52 on the clutch drum 44 side, a spring bearing plate 56 is fitted into the outer peripheral surface of the base member 41, and an inner peripheral part of the spring bearing plate 56 is brought into abutment against a snap ring 57 that is fixed to the outer peripheral surface of the base member 41, whereby the spring bearing plate 56 is inhibited from moving to one side of the direction of the axis.

In addition, a return spring 58 for urging the second piston 52 in a direction of separating it from the spring bearing plate 56 is interposed between the second piston 52 and the spring bearing plate 56. The second piton 52 is urged rightward in FIG. 3 such that the abutting part 54a of the piston member 54 separates from the rightmost friction plate 47.

Moreover, a hydraulic pressure chamber 61 is defined between the bottom plate member 53 and the bottom plate part 44a, and the operating oil is supplied to this hydraulic pressure chamber 61 via an oil passage 62. Once the operating oil is supplied to this hydraulic pressure chamber 61, the bottom plate member 53 moves to the left in FIG. 3 against the urging force of the return spring 58, and accordingly the abutting part 54a of the piston member 54 abuts against the rightmost friction plate 47 and presses this friction plate 47. As a result, the friction plates 47 and the separate plates 45 are brought into engagement and thereby the gear stage of the automatic transmission 24 is changed.

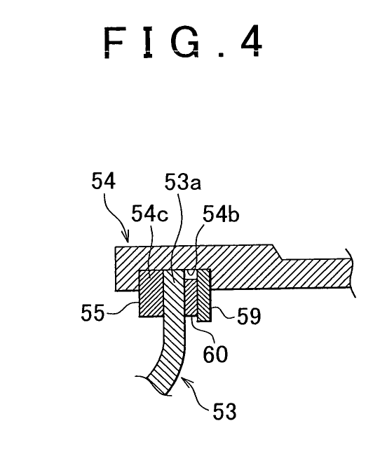

On the other hand, as shown in FIG. 4, an inner peripheral groove 54b is formed on an inner peripheral surface of the other end of the piston member 54 in the direction of the axis. The snap ring 55 is fitted into this inner peripheral groove 54b along with a radiation direction outer end 53a of the bottom plate member 53 that is held by the snap ring 55.

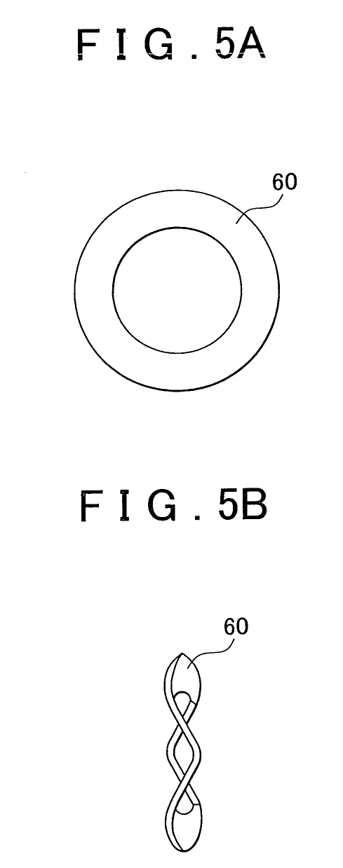

A snap ring 59 is also fitted into the inner peripheral groove 54b. A wave washer 60 serving as an urging member is attached to this snap ring 59. The wave washer 60 is formed into a wave along a peripheral direction, as shown in FIG. 5.

The wave washer 60 is interposed on the inner peripheral groove 54b via the snap ring 59. This wave washer 60 urges the radiation direction outer end 53a of the bottom plate member 53 against a wall surface 54c of the inner peripheral groove 54b in the direction of the axis, to prevent the occurrence of looseness between the piston member 54 and the bottom plate member 53.

In this embodiment, the second piston 52, the clutch drum 44, the sun gear S2, the clutch hub 46, the ring gear R2, the separate plates 45, and the friction plates 47 configure the frictional engagement device.

In this embodiment, the first frictional engagement element 42 and the second frictional engagement element 43 are assembled into the automatic transmission 24, and thereafter the piston member 54 is assembled into the bottom plate member 53 such as to cover the first frictional engagement element 42 and the second frictional engagement element 43. At this moment, the wave washer 60 urges the radiation direction outer end 53a of the bottom plate member 53 against the wall surface 54c of the inner peripheral groove 54b in the direction of the axis to prevent the occurrence of looseness between the piston member 54 and the bottom plate member 53. As a result, the space between the rightmost friction plate 47 and the abutting part 54a of the piston member 54 can be managed easily.

As shown in FIG. 2, on the other hand, in the case of shifting the automatic transmission 24 to any of the 4^{th} to 6^{th} speeds, when the operating oil is supplied to the hydraulic pressure chamber 61 via the oil passage 62, the bottom plate member 53 moves to the left in FIG. 3 against the urging force of the return spring 58, and consequently the abutting part 54a of the piston member 54 presses the rightmost friction plate 47. As a result, the friction plates 47 and the separate plates 45 are brought into engagement.

In this embodiment, because the wave washer 60 urges the radiation direction outer end 53a of the bottom plate member 53 against the wall surface 54c of the inner peripheral groove 54b in the direction of the axis to prevent the occurrence of looseness between the bottom plate member 53 and the piston member 54, the friction plates 47 and separate plates 45 can be brought into engagement via the bottom plate member 53 and the piston member 54 by supplying a required amount of operating oil to the hydraulic pressure chamber 61. Therefore, increase of engagement shock, i.e., transmission shock, can be prevented.

Furthermore, in this embodiment, because the occurrence of looseness between the bottom plate member 53 and the piston member 54 can be prevented, the bottom plate member 53 and the piston member 54 can be prevented from moving relatively to each other under operating hydraulic pressure, when bringing the friction plates 47 and the separate plates 45 into engagement. Therefore, a drastic change in the pressure of the operating oil can be prevented, and the hydraulic characteristic can be made smooth.

Moreover, in the case of shifting the automatic transmission 24 to any of the 1^{st} to 3^{rd} speeds, when the supply of the operating oil to the hydraulic pressure chamber 61 is stopped, the bottom plate member 53 is urged by the return spring 58 and moves to the right in FIG. 3, and then the abutting part 54a of the piston member 54 separates from the rightmost friction plate 47, whereby the engagement between the friction plates 47 and the separate plates 45 is released.

In this embodiment, because the occurrence of looseness between the bottom plate member 53 and the piston member 54 can be prevented, it is possible to prevent the bottom plate member 53 and the piston member 54 from being moved relative to each other by the urging force of the return spring 58, when the engagement between the friction plates 47 and the separate plates 45 is released. As a result, the pressure of the operating oil drained from the hydraulic pressure chamber 61 can be prevented from drastically changing, and the hydraulic characteristic can be made smooth.

Therefore, not only is it possible to eliminate the conventional cushion plate, but also it is possible to reduce the entire length, the number of parts, and the production cost of the automatic transmission 24.

In addition, when the cushion plate exists, a time lag, which is a time period during which the cushion plate is bent when bringing the friction plates 47 and the separate plates 45 into engagement that is when changing the speed, extends a time period during which the friction plates 47 and the separate plates 45 are brought into engagement.

In this embodiment, however, since the cushion plate can be eliminated, the piston member 54 may be moved by the distance between the abutting part 54a of the piston member 54 and the piston member 54, and therefore the time period during which the friction plates 47 and the separate plates 45 are brought into engagement can be reduced.

Moreover, in this embodiment, the simply configured, inexpensive wave washer 60 can be used as the urging member to prevent looseness from occurring between the bottom plate member 53 and the piston member 54. As a result, not only is it possible to assemble the automatic transmission 24 without any difficulty but also it is possible to prevent an increase of the production cost of the automatic transmission 24.

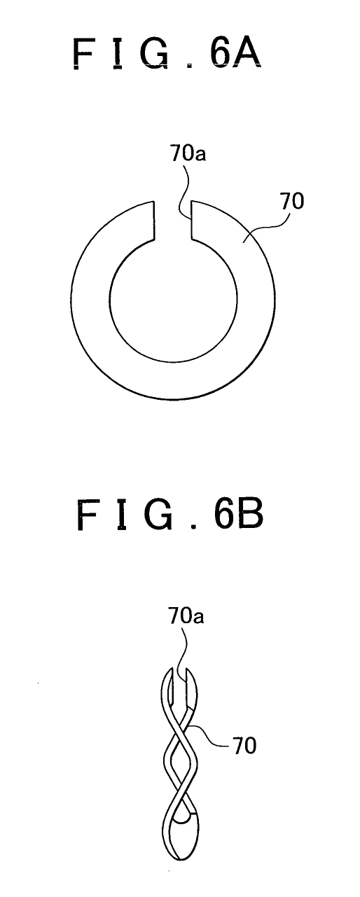

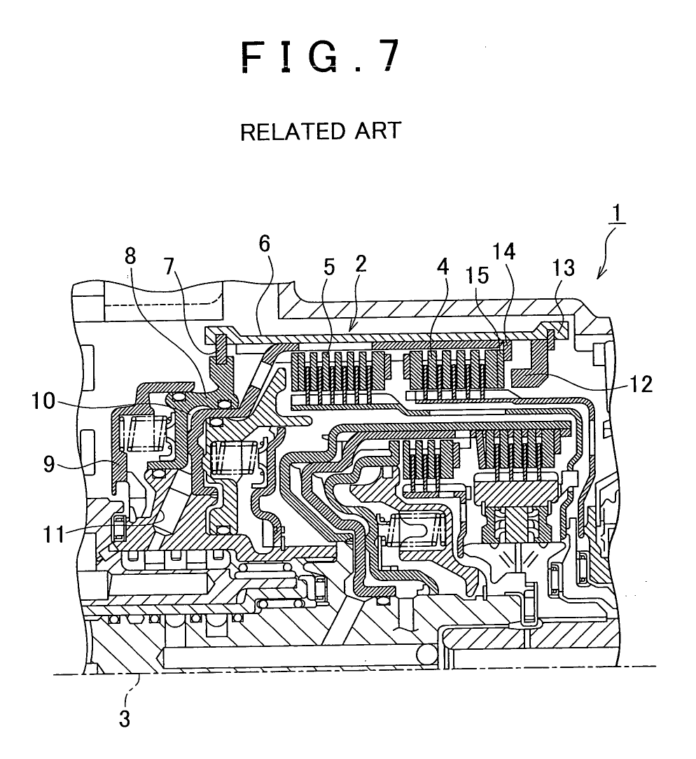

The annular wave washer 60 is used in this embodiment, but a cutout part 70a may be formed on a part of a wave washer 70, as shown in FIG. 6. Therefore, when punching the wave washer 70 out of a single steel plate or the like by means of pressing, the cutout part 70a can be positioned on an end of the steel plate to use this end effectively, so that yield can be prevented from decreasing during the production of the wave washer 70. Also, although the frictional engagement device is applied to the clutch C1 and the clutch C2 in this embodiment, the frictional engagement device may be applied to the brakes. In other words, the invention can be applied to a frictional engagement device that has an engaging/releasing part for establishing and releasing engagement between the first friction plate and the second friction plate.

Moreover, although the wave washer 60 is used as the urging member in this embodiment, a rubber or other annular elastic member that is simpler and cheaper than the wave washer 60 may be used. In addition, a small compression spring may be interposed between the radiation direction outer end 53a of the bottom plate member 53 and the snap ring 59, and this compression spring may be disposed at a regular interval between the radiation direction outer end 53a of the bottom plate member 53 and the snap ring 55.

Furthermore, the embodiment disclosed herein is merely an example, and the invention is not limited to this embodiment. The scope of the invention is not limited to the explanation of the embodiment but is defined by the claims, and therefore is intended to include meanings equivalent to the claims and al changes made within the scope of the claims.

As described above, the frictional engagement device according to the invention has the effects of not only reducing the engagement shock while making the hydraulic characteristic smooth, but also reducing the size and production cost of the frictional engagement device by preventing looseness from occurring between the bottom plate member and the piston member. The invention can also be utilized as a frictional engagement device that has an engaging/releasing part that establishes and releases the engagement among a plurality of friction plates.

What is claimed is:

1. A frictional engagement device, comprising:
a first cylindrical member;
a plurality of first friction plates that are fitted into an inner peripheral surface of the first cylindrical member and arranged in a direction of an axis of the first cylindrical member;
a second cylindrical member provided in an inner peripheral part of the first cylindrical member;
a plurality of second friction plates that are provided on an outer peripheral surface of the second cylindrical member and arranged in a direction of an axis of the second cylindrical member so as to be interposed alternately with the first friction plates; and
an engaging/releasing part that is provided in an outer peripheral part of the first cylindrical member to establish and release engagement between each first friction plate and each second friction plate, and includes a tubular piston member that has an abutting part, one end of which in the direction of the axis can be abutted against either the first friction plate or the second friction plate, a bottom plate member, a radiation direction outer end of which is fitted into an inner peripheral groove formed on the other end of the piston member in the direction of the axis and which defines a hydraulic pressure chamber between the first cylindrical member and the bottom plate member, and an urging member that is interposed on the inner peripheral groove of the piston member and urges the radiation direction outer end of the bottom plate member against a wall surface of the inner peripheral groove in the direction of the axis.

2. The frictional engagement device according to claim 1, wherein the urging member is configured with a wave washer that is formed into a wave along a peripheral direction.

3. The frictional engagement device according to claim 2, wherein a cutout part is formed in a part of the wave washer.

4. The frictional engagement device according to claim 1, wherein the urging member is configured with an annular elastic member.

5. The frictional engagement device according to claim 4, wherein the urging member is configured with a compression spring that is disposed at a regular interval in a peripheral direction of the inner peripheral groove.

6. The frictional engagement device according to claim 1, wherein the urging member is interposed on the inner peripheral groove via a snap ring.
